(19) United States
(12) Patent Application Publication
(10) Pub. No.: US 2012/0221324 A1
(43) Pub. Date: Aug. 30, 2012

(54) Document Processing Apparatus

(75) Inventors: Kimiyoshi Machii, Hitachinaka (JP); Kaoru Kawabata, Hitachi (JP); Takeshi Yokota, Hitachi (JP); Yoshiyuki Kobayashi, Sayama (JP); Masakazu Fujio, Fuchu (JP)

(73) Assignee: Hitachi, Ltd., Tokyo (JP)

(21) Appl. No.: 13/397,497

(22) Filed: Feb. 15, 2012

(30) Foreign Application Priority Data
Feb. 28, 2011 (JP) 2011-041117

(51) Int. Cl. G06F 17/27

(52) U.S. Cl. 704/9

(57) ABSTRACT

In a text document processing apparatus, there is provided standard knowledge network data composed of networked phrases having strong mutual relation to each other, the phrases being selected from a knowledge field including contents of a text document to be examined. In addition, there is provided a document knowledge preparing function that prepares knowledge network data of the document to be examined, the knowledge network data being composed of networked phrases having strong mutual relation to each other, the phrases being selected from the text document. Further, a processing unit that checks a specified word constituting the knowledge network data of the document to be examined and a standard knowledge network data, and in a case when information of phrases which are networked to the specified word are different from each other, outputs difference information including information of the specified word.

### CROSS REFERENCE TO RELATED APPLICATIONS

This application claims the benefit of Japanese Patent Application No. 2011-1-041117 filed on Feb. 28, 2011, the disclosure of which is incorporated herein by reference.

### BACKGROUND OF THE INVENTION

1. Field of the Invention

The present invention relates to a system of processing a document which takes less time and labor.

2. Description of the Related Art

One of the techniques in the related art is disclosed in Japanese Laid-Open Patent Application, Publication No. 2009-110405 (to be referred to as Patent Document 1 hereinafter). Patent Document 1 describes that “The document data processing apparatus . . . (snip) . . . extracts a related concept name of a concept name extracted by the first extraction means, and in a case when the related concept name does not contain a concept name extracted by the second extraction means . . . (snip) . . . determines that expression to be described is missing” (see [0008]). That is, in Patent Document 1, it is determined whether or not an item to be described in a document is actually described.

Patent Document 1 is based on the premise that the document is described in table format, and the table contains data such as device information, defect symptom of a device and defect report. The device information and the defect symptom are predefined in ontology, and the apparatus determines whether or not the device information and the defect symptom are described in the report.

Other techniques in the related art are disclosed in Japan Patent Publication No. 4009937 (to be referred to as Patent Document 2 hereinafter) and Japan Patent Publication No. 3099298 (to be referred to as Patent Document 3 hereinafter). Patent Documents 2 and 3 disclose a technique of selecting an arbitrary word and extracting the location at which the word appears in a document. Patent Document 2 discloses a technique which dynamically determines a word to be retrieved and related word, and then displays them in accordance with the frequency of appearance. Patent Document 3 discloses a technique which retrieves a document in accordance with a specified word count or a specified retrieval range.

In contracting process, it is necessary to read a requirement specification provided by a client and check whether or not there is a critical passage which may be disadvantageous to own side. When carrying out this process with a support system, since the terms and format of the requirement specification may vary client by client, it is substantially difficult to implement the system assuming specific terms and format.

In Patent Document 1, for example, items which can be used as components in the table are predefined in the ontology. So, only the defined items can be described in the table. However, in a practical sense, if specific format is assumed, it is impossible to deal with all requirement specifications provided by clients. Therefore, it is required to be able to compare the requirement specifications and own techniques and extract a critical passage regardless of the format.

When using techniques according to Patent Documents 2 and 3, only if a critical phrase are given in advance, it may be possible to obtain a candidate of critical passage by performing keyword search using the critical phrase. However, if an unknown item is contained in the document, it is impossible to perform the keyword search because the phrase to be used for the keyword search is also unknown.

### SUMMARY OF THE INVENTION

Therefore, it is an objective of the present invention to be able to extract a description related to unknown items.

There is provided a document processing apparatus reading a document and extracting a feature therefrom. The apparatus includes knowledge network data of phrases configured on the basis of relations between phrases in the document, compares a document structure extracted from the document with the knowledge network data, extracts a feature of contents of the document by examining the degree of similarity between the phrases and giving a higher score to the phrases having the higher similarity.

In addition, the document processing apparatus includes: a deviation/clarification sentence selection function that selects a deviation/clarification sentence data on the basis of the feature extracted by the difference extraction function; and a deviation/clarification output function that outputs deviation/clarification of the inputted document on the basis of the deviation/clarification sentence selected by the deviation/clarification sentence selection function.

With respect to a component that is present in the knowledge network data but not in the inputted document, the deviation/clarification sentence selection function selects a predefined sentence regardless of the component. With respect to a component that is present in the inputted document but not in the knowledge network data, the deviation/clarification sentence selection function selects a deviation/clarification sentence stored in the knowledge network data.

In addition, the document processing apparatus is provided with a structure extracting function that analyzes a document structure by analyzing the construction of a contract.

Further, the document processing apparatus makes the extracted feature be indicated on at least one of the knowledge network data and the document structure data.

Still further, the document processing apparatus is provided with a user interface and a function for adding the extracted feature to the knowledge network.

In addition, the document processing apparatus compares the knowledge network data and the document structure, and then displays the matching portions.

The present invention makes it possible to compare the requirement specification and own techniques and extract a critical passage or a matching portion regardless of the format of a requirement specification provided by the customer.

### BRIEF DESCRIPTION OF THE DRAWINGS

FIG. 1 is a diagram illustrating a software configuration of the document processing apparatus;

FIG. 2 is a diagram illustrating a hardware configuration of the document processing apparatus;

FIG. 3 is a diagram illustrating an example of description of a requirement specification 101;

FIG. 4 is a data structure diagram illustrating a standard component structured data 103;

FIG. 5 is a structure diagram illustrating a deviation/clarification sentence data 104;

FIG. 6 is a processing flow of a document structure analysis part 105;

FIG. 7A to 7C are diagrams each illustrating a specific example of the processing flow of the document structure analysis part 105;

FIG. 8 is a conversion table 800 for converting a verb and a preposition to a predicate;

FIG. 9 is a processing flow of a structural difference extraction part 106;

FIG. 10 is a processing flow of matching between a triple and standard component structured data 103;

FIG. 11 is a processing flow of matching between a triple extracted from the standard component structured data 103 and data extracted by the document structure analysis part 105;

FIG. 12 shows a structure of a critical passage buffer;

FIG. 13 is a processing flow of a deviation/clarification sentence selection part 108;

FIG. 14 shows the main screen of the system;

FIG. 15 is an example of a deviation/clarification 111;

FIG. 16 is a diagram illustrating the screen of an edit HMI 110;

FIGS. 17A and 17B are diagrams each illustrating a structural data display screen 1701; and

FIG. 18 is a diagram illustrating another software configuration of the document processing apparatus.

### DETAILED DESCRIPTION OF THE EXEMPLARY EMBODIMENT

Below are described embodiments of the present invention with reference to related drawings.

### First Embodiment

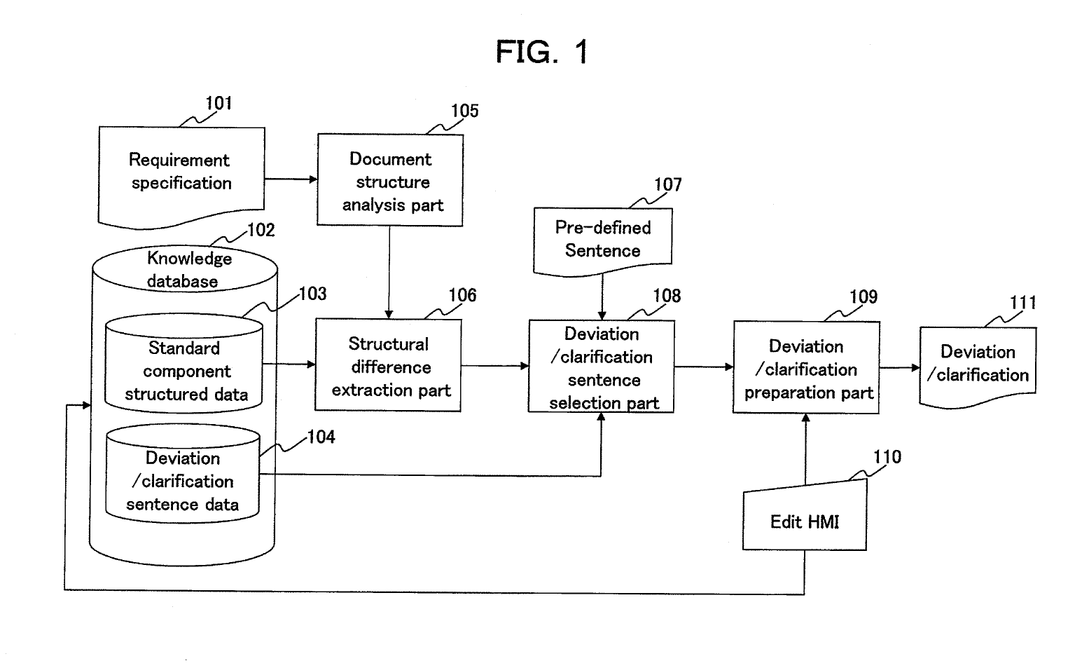

FIG. 1 is a diagram illustrating a configuration of the document processing apparatus according to an embodiment of the present invention. If a requirement specification 101 is inputted, the structure of the document included therein is analyzed by a document structure analysis part 105. More specifically, a structure, chaptering, and the like of a sentence described in the requirement specification 101 are analyzed. A result of the processing by the document structure analysis part 105 is transmitted to a structural difference extraction part 106, and then a difference from a standard component structured data 103 is extracted. A deviation/clarification sentence selection part 108 selects a response sentence used when preparing a deviation/clarification 111, based on a result of the structural difference extraction part 106. The response sentence is prepared by either using the predefined sentence 107 or using a deviation/clarification sentence data 104 stored in a knowledge database 102. A deviation/clarification preparation part 109 prepares the deviation/clarification 111 based on the response sentence selected by the deviation/clarification sentence selection part 108 and the difference extracted by the structural difference extraction part 106. Further, the deviation/clarification 111 can be edited via an edit HMI 110.

As described above, the requirement specification 101 is an item to be examined, or a text document to be examined.

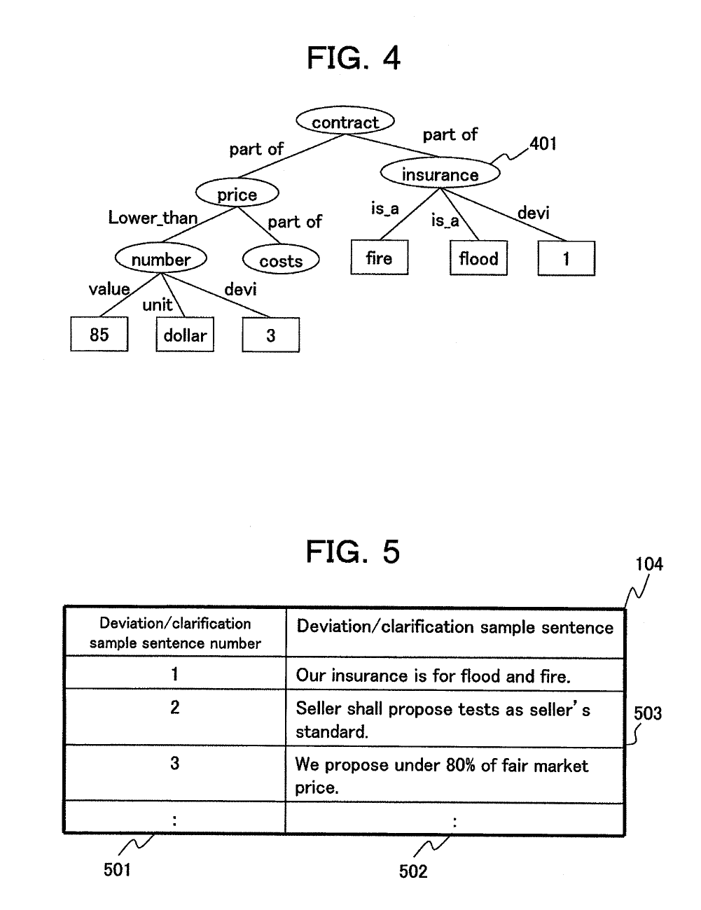

The standard component structured data 103 is standard knowledge network data composed of networked phrases having strong mutual relation to each other. The phrases are selected from a knowledge field including contents of a text document to be examined. Details are described hereinafter with reference to FIG. 4.

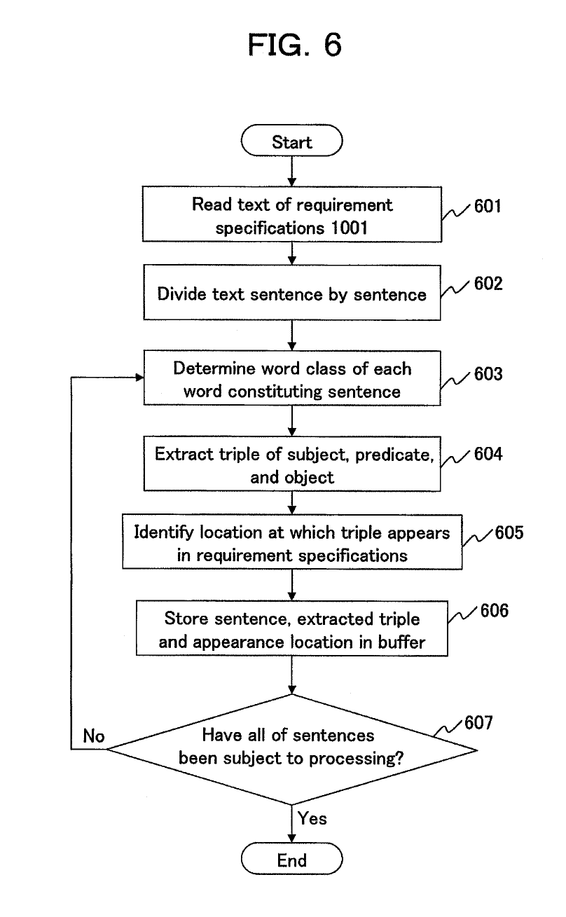

The document structure analysis part 105 is a document knowledge preparing function that prepares knowledge network data of document to be examined. The knowledge network data is composed of networked phrases having strong mutual relation to each other, and the phrases are selected from the text document. Details are described hereinafter with reference to FIG. 6.

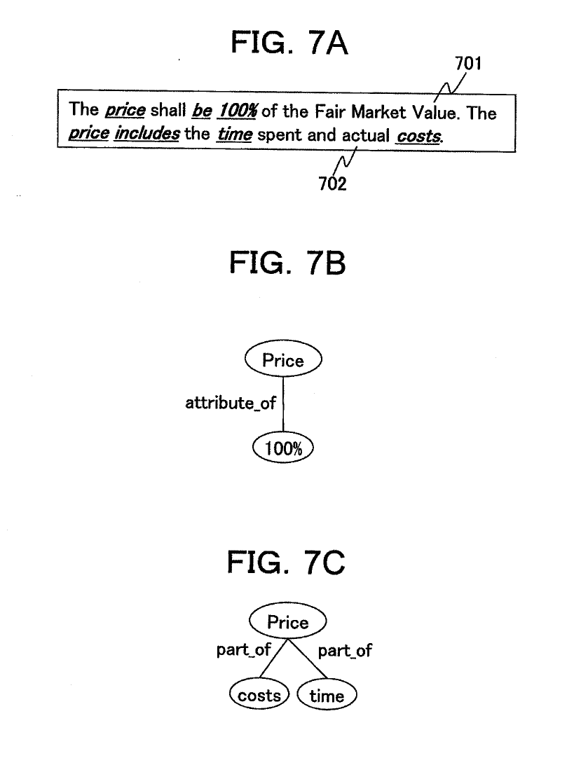

The knowledge network data of a document to be examined, which has been prepared by the document structure analysis part 105, is composed of networked phrases having strong mutual relation to each other. Details are described hereinafter with reference to FIG. 7.

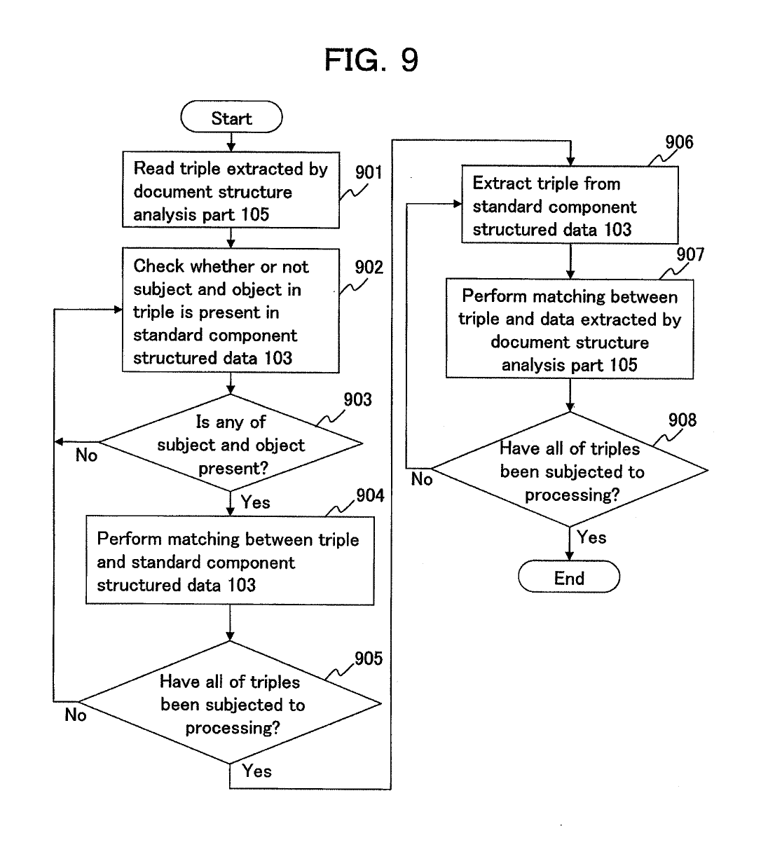

The structural difference extraction part 106 is a processing means that checks a specified word constituting the knowledge network data of a document to be examined and a standard knowledge network data. In a case when information of phrases which are networked to the specified word are different from each other, the structural difference extraction part 106 outputs difference information including information of the specified word. Details are described hereinafter with reference to FIG. 9.

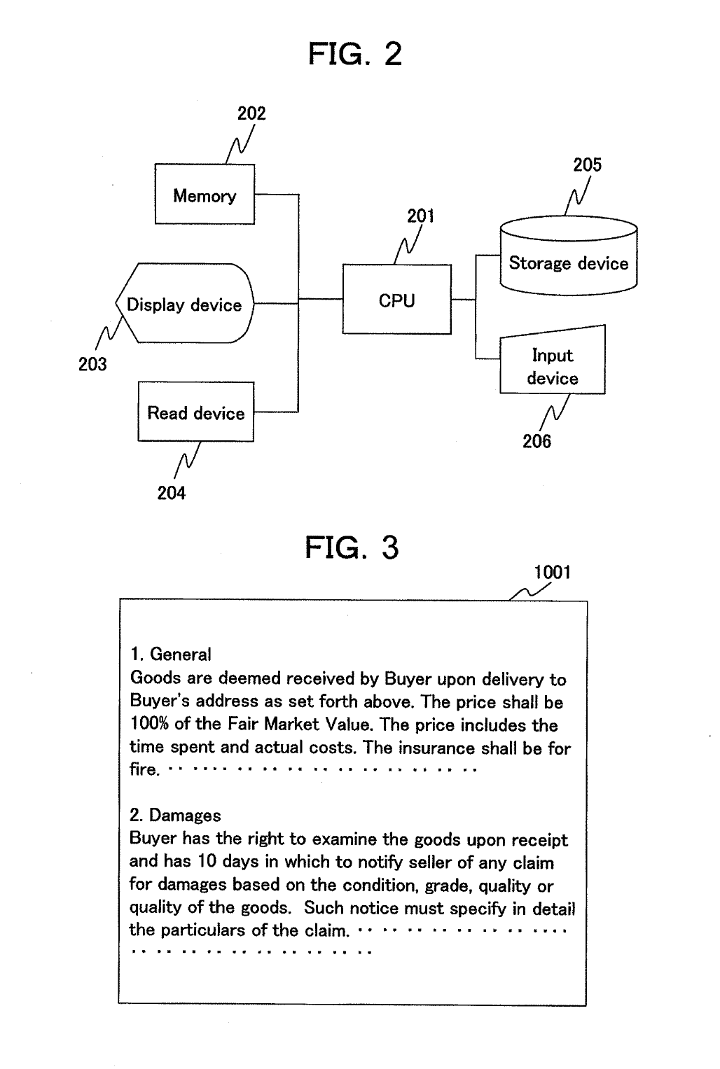

FIG. 2 is a diagram of a hardware configuration in the present invention. A CPU 201 controls all processes in the present invention. A memory 202 holds data required in this embodiment until operations of the system are terminated. A display device 203 displays a processing result and presents the result to a user. A liquid crystal display or a CRT (Cathode Ray Tube) monitor is used as the display device 203. A read device 204 reads the requirement specification 101. A scanner or the like is used as the read device 204. The read device 204 may be equipped with software for generating a text data of the requirement specification 101. For example, OCR (Optical Character Recognition) is used. However, the read device 204 is not always necessary if the requirement specification 101 is a text data. The read device 204 is necessary only if the requirement specification 101 is printed on paper. A storage device 205 is used for maintaining the knowledge database 102 or an item data buffer. For example, a hard disk (HDD) is used as the storage device 205. Further, if there is necessary data other than the knowledge database 101, such as the deviation/clarification 111 and a proposed specification 112, the data is stored in the storage device 205 during or after program execution. An input device 206 is a device to which a user inputs data such as an edit of the deviation/clarification 111 or a selection of a proposed specification template. A keyboard or a mouse is used as the input device 206.

FIG. 3 is an example of description of the requirement specification 101. Disclosure in this embodiment is made with regard to contents described in FIG. 3.

FIG. 4 is a diagram illustrating a data structure of the standard component structured data 103. The structure represents a knowledge system using relationship between nodes. For example, “price” and “insurance” are included in “contract” and are connected to “contract” with a relationship of “part_of”. An attribute of “price” is “number” which is connected to each other with a relationship of “lower than”. “number” is connected to “85” with a relationship of “value” and is also connected to “dollar” with a relationship of “unit”. This means that “price is to be made lower than 85 dollars”. A numerical number “3” which is branched from “number” with a relationship of “devi” is a response sentence number of the deviation/clarification sentence data 104. If a response sentence includes a description which does not meet a numerical condition represented by the number node, the deviation/clarification sentence data 104 with the response sentence number has contents to be described in the deviation/clarification 111. The node “insurance” is connected to each of “fire” and “flood” with a relationship of “is_a”. This means that there are “fire” and “flood” as types of “insurance”. As described above, what describes the knowledge system using various relationships between nodes is the standard component structured data 103. The structure as described above can be described using a language for describing a knowledge system such as RDF (Resource Description Framework), OWL (Web Ontology Language), or the like.

FIG. 5 is a diagram illustrating a structure of the deviation/clarification sentence data 104. The deviation/clarification sentence data 104 includes a deviation/clarification sample sentence number 501 and a deviation/clarification sample sentence 502. In the above-described example of the node “number”, if an item which does not meet a given numerical condition is specified in the requirement specification 101, a record 503 having the deviation/clarification sample sentence number of “3” is searched to obtain a deviation/clarification sample sentence of “We propose under 80% of fair market price”, which is automatically written in the deviation/clarification 111.

FIG. 6 is a processing flowchart of the document structure analysis part 105. Text information of the requirement specification 101 is read (step 601). The text is divided sentence by sentence (step 602). In step 602, if the text is in English, the text may be divided by, for example, a period “.”. In some cases, however, a period may be used in an abbreviation of a word. In order to exclude a possibility of an erroneous division of sentences, a dictionary containing a word whose abbreviation is possibly used may be created. Only if a period is present in a position not found in the dictionary, the period is used as a separator of sentences. After that, a processing goes into a loop for each of the divided sentences. A sentence having been divided and targeted for a processing is subjected to syntax analysis. A word class of each word constituting the sentence is determined (step 603). A triple of a subject, a predicate, and an object is extracted from the target sentence (step 604). A location at which the triple appears in the requirement specification is identified (step 605). The appearance location used herein means a location at which each of the subject, the predicate, and the object appears and is represented by a character position counted from the beginning of the requirement specification and a character string length. Finally, the sentence, the extracted triple, and the appearance location are stored in a buffer (step 606). Whether or not all of the target sentences have already been subjected to the steps described above is determined (step 607). If all of the sentences have already been subjected to the steps, the processing is terminated. If not, the steps after step 603 are repeated.

FIG. 7A to FIG. 7C are diagrams each illustrating a specific example of the processing flowchart shown in FIG. 6. Description below is made referring to a sentence 701 and a sentence 702 shown in FIG. 7A. An example of extracting a triple from the sentence 701 is illustrated in FIG. 7B. In the sentence 701, a subject of is “price”, a verb is “be”, an object is “100%”. As shown in FIG. 7B, “price” and “100%” are linked by a predicate of “attribute_of”. FIG. 7C illustrates an analysis result of a sentence 702. In the sentence 702, a subject is “price”, a verb is “includes”, and objects are “time” and “costs”. As shown in FIG. 7C, “price” as the subject is linked with each of “time” and “costs” by “part_of” as the predicate.

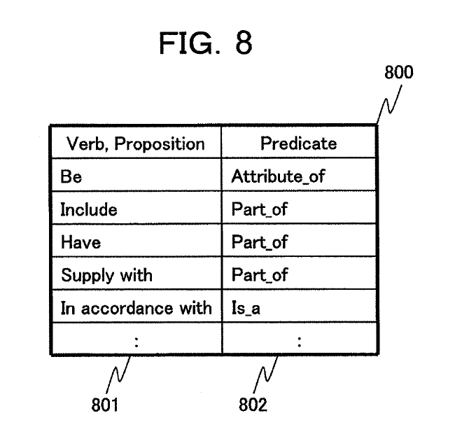

FIG. 8 is an example of a conversion table 800 which contains conversion from a verb and a preposition to a predicate when a triple is extracted. The predicate of the triple is converted using the verb and the preposition. In the example shown in FIG. 7, “be” and “includes” are extracted as verbs. First, respective columns 801 are searched for “be” and “includes”, which are then converted into predicates shown in respective corresponding columns 802, that is, “attribute_of” and “part_of” as respective relationships.

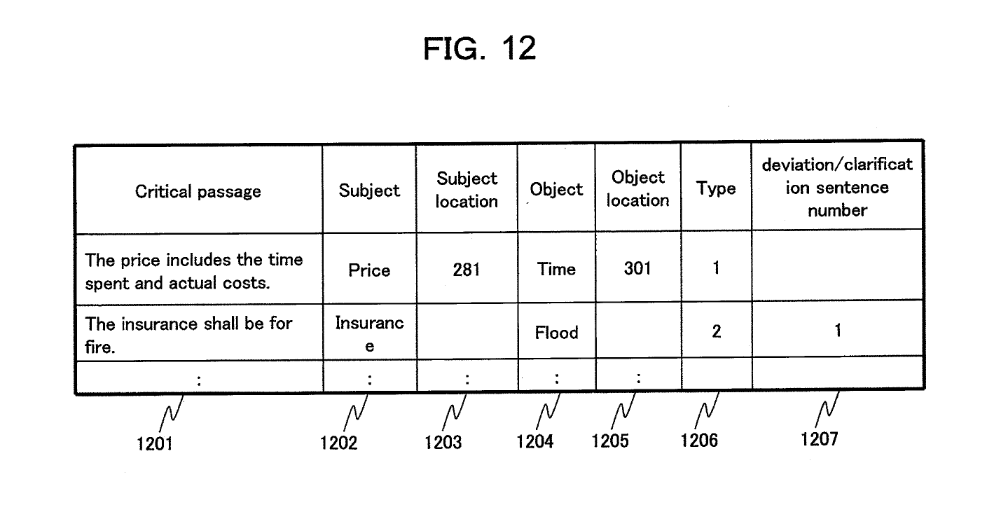

FIG. 9 is an example of a processing flowchart of the structural difference extraction part 106. First, the triple extracted by the document structure analysis part 105 is read. Note that the processing described below is performed to each of the extracted triples. Next, whether or not one of a subject and an object in the triple is present in the standard component structured data 103 is checked (step 902). Step 902 is performed because whether or not a description not relevant to the standard component structured data 103 has been made (step 903). If it is determined that neither the subject nor the object is present, the processing returns to step 902, and the next triple is subjected to the processing. On the other hand, if at least one of the subject and the object is present, matching is performed between the triple and the standard component structured data 103 (step 904). Finally, whether or not all of the triples have been subjected to the processing is determined (step 905). If not all of the triples have been subjected to the processing, the processing returns to step 902, and the next triple is subjected to the processing. On the other hand, if all of the triples have already been subjected to the processing, the processing advances to step 906. In steps 901 to 905, a component that is present in the requirement specification 101, but not in the standard component structured data 103 is extracted. In other words, in steps 901 to 905, if a component which is not present in an own standard specification is specified, the component is extracted as a critical passage. Meanwhile, the component that is extracted in steps 901 to 905 and is present not in the standard component structured data 103 but in the requirement specification 101 may also be referred to as second difference information. The second difference information is present in a knowledge network data of document to be examined, but not in a standard knowledge network data and will be hereinafter described in detail with reference to FIG. 12.

In contrast to the steps up to step 905, in the following steps in and after step 906, a component that is present in the standard component structured data 103, but not in the requirement specification 101 will be extracted. In step 906, a triple is extracted from the standard component structured data 103. Then matching is performed between the triple and the data extracted by document structure analysis part 105 (step 907). It is determined whether or not all triples have been extracted from the standard component structured data 103, and whether or not all triples have been subjected to a matching processing (step 908). If all triples have been processed, the processing is completed and terminated. If not, the processing returns to step 906 and continues the processing. The component which has been extracted in steps 906 to 908 and is present not in the requirement specification 101 but in the standard component structured data 103 may also be referred to as first difference information. The first difference information is present in the standard knowledge network data but not in the knowledge network data of document to be examined, and will be hereinafter described in detail with reference to FIG. 12.

Steps 901 to 905 can be performed independently from steps 906 to 908 or in reverse order.

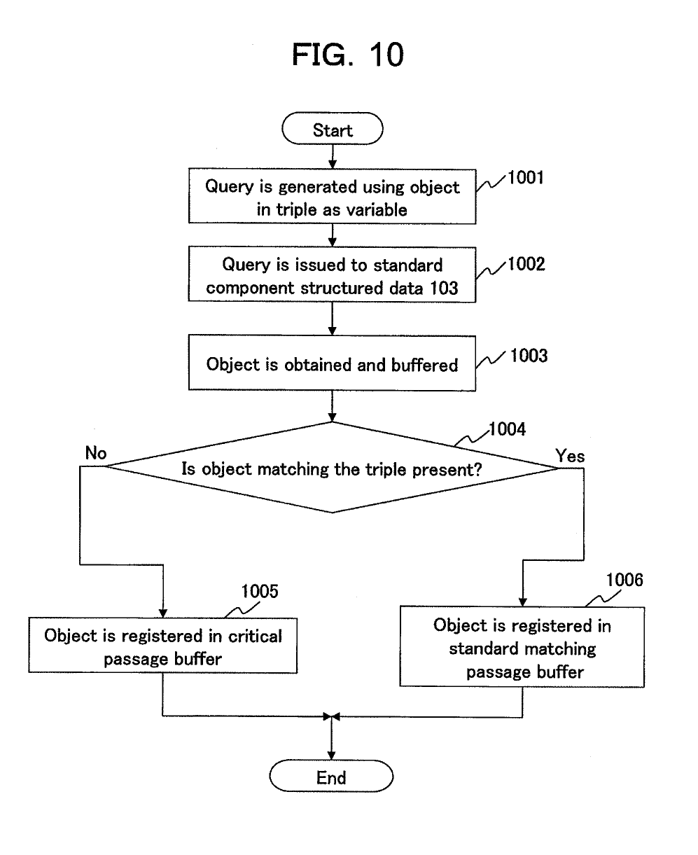

FIG. 10 is an example of a flowchart of the matching processing between the triple and the standard component structured data 103 performed in step 904. A query is generated which is used for inquiring whether or not an object matching a subject and a predicate in the triple is present, using the object in the triple as a variable (step 1001). A query by, for example, SPARQL (SPARQL Protocol and RDF Query Language) is suitably used herein. The query is issued to the standard component structured data 103 (step 1002). The object or objects matching the triple having the subject and the predicate are then obtained and buffered (step 1003). Next, whether or not the object matching the triple is present among the obtained object or objects is determined (step 1004). If present, it means that the object is present in the standard component structured data 103, the object is not extracted as a critical passage but is registered in a standard matching passage buffer (step 1006). The standard matching passage buffer is a data for use in displaying a passage that matches a standard component on a screen. On the other hand, if the object matching the triple is not present, it means that the object is not present in the standard component structured data 103 and is regarded as containing a component that is not standard, and the object is registered in the critical passage buffer (step 1005).

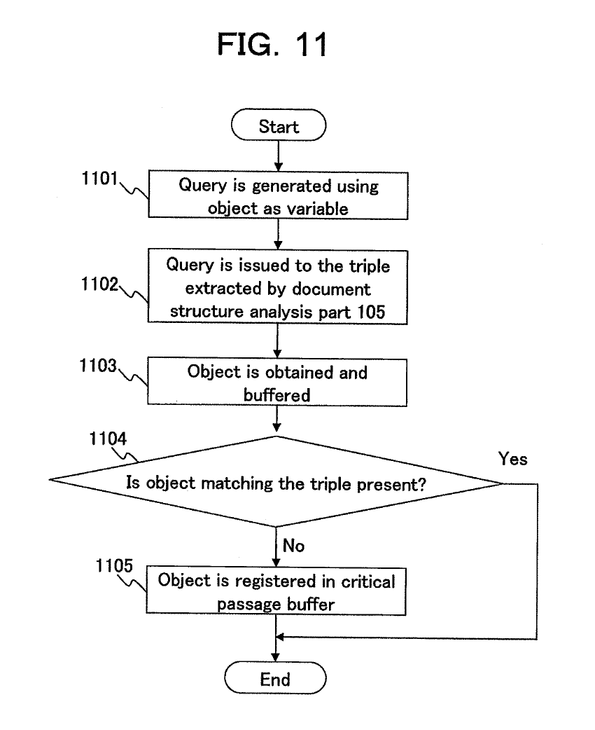

FIG. 11 is an example of a processing flowchart in which the triple extracted from the standard component structured data 103 in step 907 is matched with the data extracted from the document structure analysis part 105. A query is generated using an object of the triple extracted from the standard component structured data 103, as a variable (step 1101). A query by SPARQL (SPARQL Protocol and RDF Query Language) is suitably used herein, similarly to the query in the processing flowchart of FIG. 10. A query is issued to the triple extracted by the document structure analysis part 105 (step 1102). As a result, an object matching a triple having the subject and the predicate is obtained and is buffered (step 1103). Next, whether or not an object matching the triple is present in the obtained object or objects is checked (step 1104). If present, it means that the object is present in the requirement specification 101, and thus, the object is not critical. If not present, the object is registered in the critical passage buffer (step 1105). Note that the processing of FIG. 11 is performed for extracting a component which is present in own standard specification but is not required from a customer. Thus, the component is not always critical. Rather, the processing of FIG. 11 is performed for extracting a component necessary to draw an attention to the customer.

FIG. 12 is an example of a configuration of a critical passage buffer, that is, difference information. The critical passage buffer is created in the memory 202 and is not necessarily stored in the storage device 205. However, the critical passage buffer may be also suitably created in the storage device 205. A critical sentence column 1201 contains a sentence which contains a critical passage and is an original sentence having the triple. A subject column 1202 contains a subject of the triple determined to be critical in the processing of FIG. 10. A subject location column 1203 contains a starting location of the subject in the requirement specification 101. An object column 1204 contains an object of the triple determined to be critical in the processing of FIG. 10. An object location column 1205 contains a starting location of the object in the requirement specification. A type column 1206 contains a flag indicating how a critical passage is detected. More specifically, the type column 1206 contains “1” if the component is not present in the standard component structured data 103 but is present in the requirement specification 101. The type column 1206 contains “2” if the component is not present in the requirement specification 101 but is present in the standard component structured data 103. In the former case, the subject column 1202 and the object column 1204 contain respective phrases based on the description in the requirement specification 101; and the subject location column 1203 and the object location column 1205 also contain respective phrases based on the description in the requirement specification 101. On the other hand, in the latter case, the subject column 1202 and the object column 1204 contain the subject and object of the standard component structured data 103, and the subject location and the object location leave blank. The deviation/clarification sentence number column 1207 represents a number of a response sentence described in the deviation/clarification 111. This is stored in the standard component structured data 103, and is represented with a relationship of “devi” in FIG. 4. In the case of node 401 for example, “1” is connected with a relationship “devi”. Therefore a passage specified as “1” with the deviation/clarification sentence number will be described in the deviation/clarification 111.

Further, the structure of the critical passage buffer may be used also for the standard matching passage buffer. In this case, type column 1206 and deviation/clarification sentence number 1207 may leave blank.

As described above, difference information in the column shown with type “1” is a component that is not present in the standard component structured data 103 but is present in the requirement specification 101. Similarly, difference information in the column shown with type “2” is a component that is not present in the requirement specification 101 but is present in the standard component structured data 103.

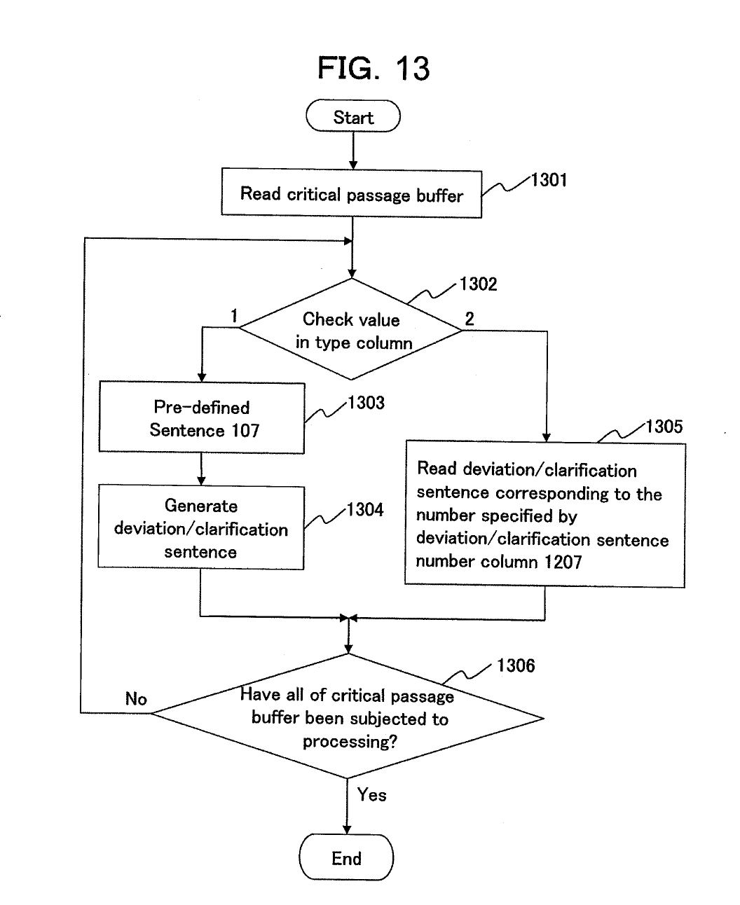

FIG. 13 is an example of a flowchart of a processing performed by the deviation/clarification sentence selection part 108. The deviation/clarification sentence selection part 108 selects a deviation/clarification sentence in accordance with a process of the extraction of a critical passage. More specifically, the deviation/clarification sentences varies between a component that is present in the standard component structured data 103 but not in the requirement specification 101 and a component that is present in the standard component structured data 103 but not in the requirement specification 101. Firstly, a critical passage buffer is read (step 1301). Next, type column 1206 is checked (step 1302). If it is “1”, the predefined sentence 107 is read (step 1303) and a deviation/clarification sentence is generated. The passage of the predefined sentence 107 is “Regarding XX, YY is not in our proposal.” At step 1304, a critical phrase is stored in “XX” and “YY”. The subject is stored in “XX” and the object is stored in “YY”. For example, in the case of the first record in FIG. 12, the deviation/clarification sentence will be “Regarding price, time is not in our proposal.” On the other hand, if the value of the type column 1206 is 2, a deviation/clarification sentence is read of which the number is specified in the deviation/clarification sentence number column 1207 (step 1305). For example, in the case of the second record in FIG. 12, a deviation/clarification sentence “Our insurance is for flood and fire.” that has a deviation/clarification sentence number of “1” in the deviation/clarification sentence data 104. Finally, it is determined whether or not all of critical passage buffer have been subjected to processing (step 1306). If all of critical passage buffer have been processed, the processing is completed and terminated. If not, the processing returns to the step 1301.

Thus, the deviation/clarification sentence selection part 108 is provided with a sentence database storing sentences associated with phrases which constitute the standard knowledge network data. Further, the deviation/clarification sentence selection part 108 is a processing means including: a first output function which retrieves a sentence in the sentence database using a word included in the first difference information as a key and outputs the retrieved sentence with the first difference information; and a second output function which outputs predefined sentence data with the second difference information.

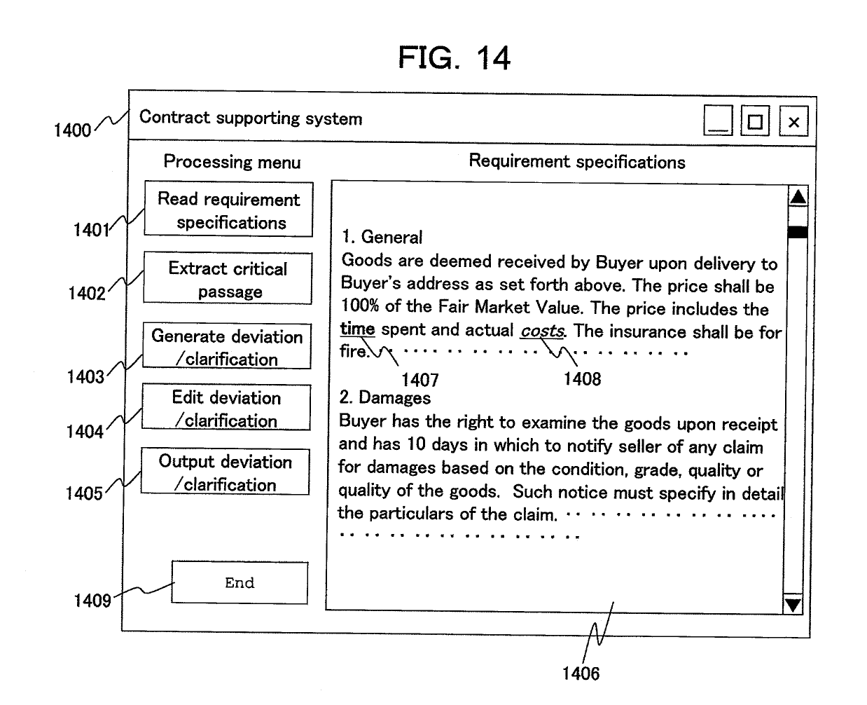

FIG. 14 shows the main screen of a system disclosed in this embodiment. The requirement specification read button 1401 is a button for reading a requirement specification 101. When critical passage extract button 1402 is clicked, a document structure analysis part 105 and a structural difference extraction part 106 are activated, and a difference between the requirement specification 101 and the standard component structured data 103 is extracted. When a deviation/clarification generate button 1403 is clicked, deviation/clarification sentence selection part 108 and a deviation/clarification preparation part 109 are activated, and a template of the deviation/clarification is generated. When a deviation/clarification edit button 1404 is clicked, an edit HMI 110 for editing the generated deviation/clarification is displayed and editing of the deviation/clarification by a user becomes possible. When a deviation/clarification output button 1405 is clicked, the passage of the deviation/clarification is stored in a spreadsheet or word-processing format. A requirement specification window 1406 is a window for displaying a passage of the requirement specification 101. Further, when a critical passage has been extracted, the critical passage is highlighted, for example in this embodiment, “time” (1407) is highlighted with different character style or different color. In addition, a passage that matches the standard component structured data 103 is highlighted, for example in this embodiment, “costs” (1408) is highlighted. The words “time” and “costs” are highlighted in different ways. When an end button 1409 is clicked, all processing is terminated. Thus, the difference information is displayed on the screen and highlighted.

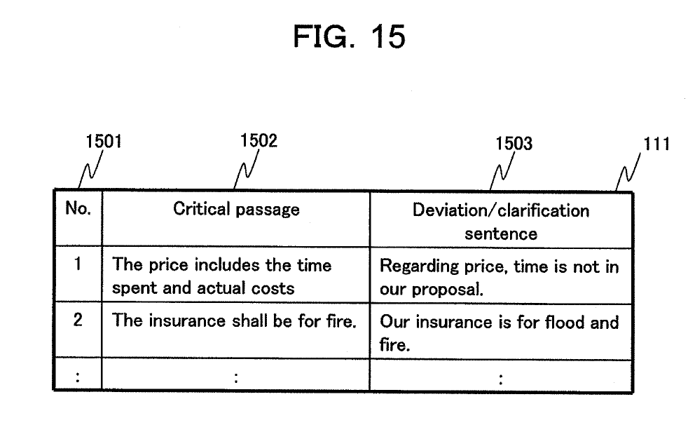

FIG. 15 is an example of the deviation/clarification 111. A column 1501 denotes a serial number provided to a component of response. A critical passage column 1502 is a sentence including a critical passage. A deviation/clarification sentence column 1503 includes a deviation/clarification sentence corresponding to each of the critical passages. The deviation/clarification 111 is stored, preferably but not necessarily, in general spreadsheet or word-processor format.

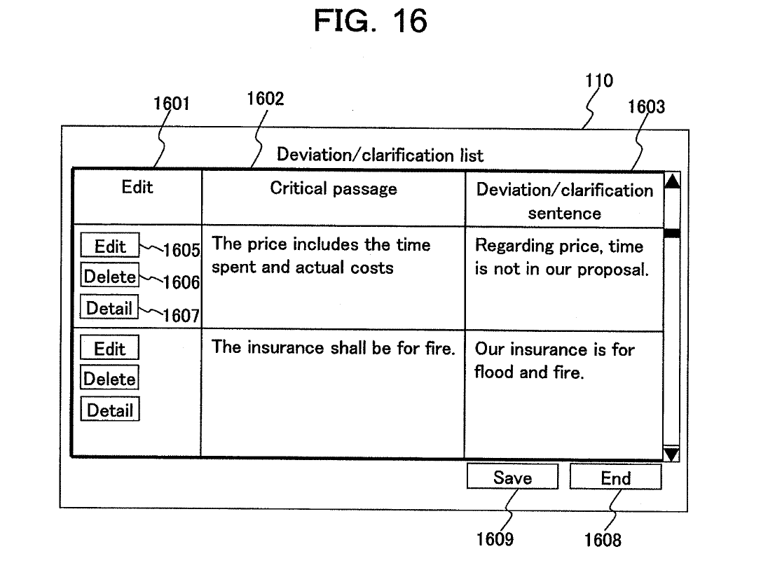

FIG. 16 is a diagram illustrating the screen of the edit HMI 110. An edit column 1601 is a column for selecting an edit options including edit and delete. When an edit button 1605 is clicked, editing a deviation/clarification becomes possible. When a delete button 1606 is clicked, the component is deleted from the deviation/clarification list. A critical passage column 1602 contains a sentence that includes a critical passage. A deviation/clarification sentence column 1603 contains a deviation/clarification sentence corresponding to the critical passage. When a save button 1609 is clicked, the edited passage is stored in a buffer. When an exit button 1608 is clicked, the edit HMI 110 disappears from the screen, and the editing process is terminated. When a details button 1607 is clicked, a screen 1701 which displays structural data of the component is displayed.

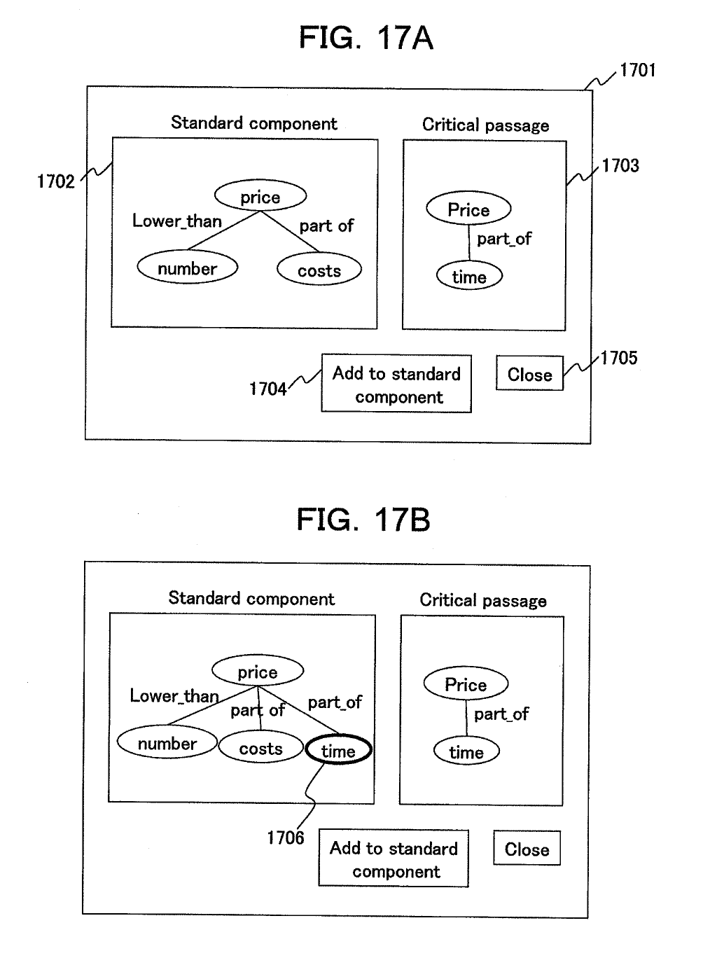

FIGS. 17A and 17B are diagrams each illustrating a structural data display screen 1701. This screen displays information about the critical passage. The information includes related passages in the standard component structured data 103 and structures of the critical passages. The information is displayed on a standard component window 1702 and a critical passage window 1703 respectively. In this state of condition, when an add button is clicked, the passage displayed on the window 1703 is added to the standard component structured data 103. FIG. 17B illustrates the detail. In this embodiment, a time node 1706 is added to the standard component structured data. When a close button 1705 is clicked, the structural data display screen 1701 disappears. Thus, it is possible to feedback the extracted result of the critical passage to the standard component structured data 103.

### Second Embodiment

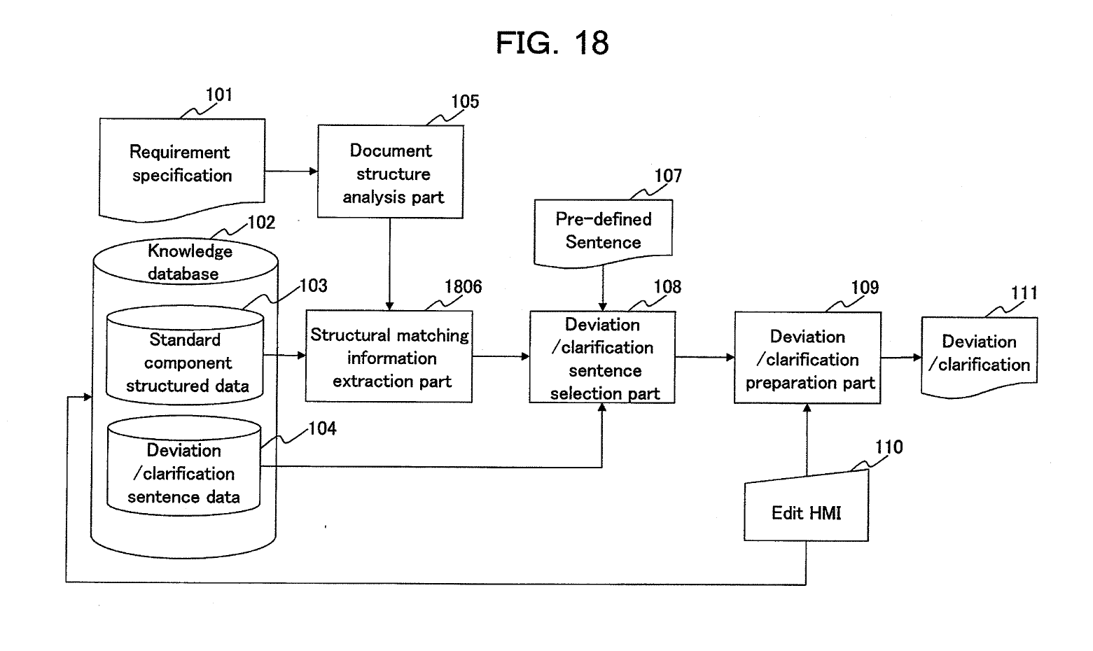

FIG. 18 is a diagram illustrating another software configuration of the document processing apparatus. What is different is that the structural difference extraction part 106 has been replaced with a structural matching information extraction part 1806. The structural matching information extraction part 1806 performs the same matching flow explained in FIGS. 10 and 11. The difference is the process at step 1004 in which whether or not an object matching the triple is present is determined. The process performed when “Yes” corresponds to the structural matching information extraction part 1806. The process performed when “No” corresponds to the structural difference extraction part 106. In addition, when determining whether or not an object matching the triple is present at the step 1104, the process performed when “Yes” corresponds to the structural matching information extraction part 1806, and the process performed when “No” corresponds to the structural difference extraction part 106. With respect to other processes such as where a critical passage can be considered as a matching passage or where difference information can be considered as matching information, the same processes will be performed. Therefore the redundant explanations will be omitted. According to this embodiment, it is possible, regardless of the format of a requirement specification provided by a client, to compare a requirement specification with own techniques and extract the matching passage. It also helps workers to extract a description about unknown items, while considering own techniques by extracting the matching passage.

FIG. 14 shows a main screen of a system disclosed in the first embodiment (or the second embodiment). It shows the screen outputted by the structural difference extraction part 106 or by the structural matching information extraction part 1806. In the first or second embodiment, the structure of a document is analyzed by the document structure analysis part 105. If the analyzed data is stored in the database as shown in FIG. 4 or 7, a further analysis may not be necessary. In other words, the structural difference extraction part 106 displays the screen of FIG. 14 in accordance with a comparison between the structures stored in the databases, namely the structure of the knowledge network data of document to be examined and the structure of the standard knowledge network data.

Thus, the present invention provides a display method of a text document processing apparatus extracting a specified description from contents of a document. The method includes: providing a database; storing standard knowledge network data (standard component structured data 103) in the database, the storing standard knowledge network data being composed of networked phrases having strong mutual relation to each other, the phrases being selected from a knowledge field including contents of a text document to be examined; storing, in the database, knowledge network data of the document to be examined (FIGS. 7B and 7C), the knowledge network data of the document to be examined being composed of networked phrases having strong mutual relation to each other, the phrases being selected from the text document; and checking a specified word constituting the knowledge network data of the document to be examined and a standard knowledge network data, and in a case when information of phrases which are networked to the specified word are different from each other or matched with each other, outputting and highlighting the difference information including information of the specified word or the matching information including information of the specified word (the structural difference extraction part 106, the structural matching information extraction part 1806). The method makes it possible to be able to compare the requirement specification and own techniques and extract a critical passage regardless of a format.

In addition, by highlighting the difference information and the matching information in different ways, the method also helps workers to check a whole document easily, while considering the critical passage and the matching passage using the display method with highlighting the difference information and the matching information in different styles.

The embodiments according to the present invention have been explained as aforementioned. However, the embodiments of the present invention are not limited to those explanations, and may be embodied in various modifications. For example, the embodiments have been explained in detail for easy understanding. Therefore, the embodiments are not limited to include all of the explained components. Further, some components in one embodiment may be replaced with other components in another embodiment. In addition, some components explained in one embodiment may be added to another embodiment. Further, some components in each of the embodiments may be added, deleted and/or replaced with other embodiments.

In addition, a part or all of the aforementioned structures, functions, processing units and processing means may be implemented in hardware, for example, by integration circuits or the like. Further, above-mentioned structures and functions may be implemented in software, i.e. programs of each of the functions executed by a processor. Information such as a program, a file, measurement information, calculated information for implementing the functions may be stored in a storage device such as a memory, a hard disc, an SSD (Solid State Drive) etc. or in a storage media such as an IC card, a SD card, a DVD, or the like. Thus, each of the processes and functions may be implemented as a processing part, a processing unit or a program module etc.

Further, control lines and information lines are illustrated d for the explanation as needed. Therefore it does not necessarily mean all of the lines of the product are shown. In a practical sense, it may be considered that virtually all of the structures are inter-connected.

1. A text document processing apparatus extracting a specified description from contents of a document, comprising:
a database storing standard knowledge network data composed of networked phrases having strong mutual relation to each other, the phrases being selected from a knowledge field including contents of a text document to be examined;
a document knowledge preparing unit that prepares knowledge network data of the document to be examined, the knowledge network data being composed of networked phrases having strong mutual relation to each other, the phrases being selected from the text document; and
a structural matching information extraction unit that checks a specified word constituting the knowledge network data of the document to be examined and a standard knowledge network data, and in a case when information of phrases which are networked to the specified word are different from each other, outputs difference information including information of the specified word.

2. The text document processing apparatus according to claim 1, wherein the difference information is at least one of:
a first difference information which is present in the standard knowledge network data but not present in the knowledge network data of document to be examined; and
a second difference information which is present in the knowledge network data of document to be examined but not present in the standard knowledge network data.

3. The text document processing apparatus according to claim 2, further comprising:
a sentence database storing a sentence associated with phrases constituting the standard knowledge network data; and
a processing unit including, a first output function which retrieves a sentence in the sentence database using a word included in the first difference information as a key and outputs the retrieved sentence with the first difference information, and a second output function which outputs predefined sentence data with the second difference information.

4. The text document processing apparatus according to claim 2, wherein when displaying the text document to be examined, a word included in the second difference information is displayed with a different character style.

5. The text document processing apparatus according to claim 2, further comprising an input unit for determining whether or not to network a word contained in the second difference information to the specified word in the standard knowledge network data.

6. A text document processing apparatus extracting a specified description from contents of a document, comprising:
a database storing standard knowledge network data composed of networked phrases having strong mutual relation to each other, the phrases being selected from a knowledge field including contents of a text document to be examined;
a document knowledge preparing unit that prepares knowledge network data of document to be examined, the knowledge network data being composed of networked phrases having strong mutual relation to each other, the phrases being selected from the text document; and
a structural matching information extraction unit that checks a specified word constituting the knowledge network data of document to be examined and a standard knowledge network data, selects information of phrases that match to each other from among information of phrases which are networked to the specified word, and outputs the selected information of phrases as matching information.

7. The text document processing apparatus according to claim 1, wherein when displaying the text document to be examined, a word included in the matching information is displayed with a different character style.

8. A display method of a text document processing apparatus extracting a specified description from contents of a document, comprising:
providing a database;
storing standard knowledge network data in the database, the standard knowledge network data being composed of networked phrases having strong mutual relation to each other, the phrases being selected from a knowledge field including contents of a text document to be examined;
storing, in the database, knowledge network data of the document to be examined, the knowledge network data of the document to be examined being composed of networked phrases having strong mutual relation to each other, the phrases being selected from the text document; and
checking a specified word constituting the knowledge network data of the document to be examined and a standard knowledge network data, and in a case when information of phrases which are networked to the specified word are different from each other or matched with each other, outputting and highlighting difference information with the specified word or matching information with the specified word.

9. The display method of a text document processing apparatus according to claim 8, wherein the difference information and the matching information are highlighted in different style.

10. The text document processing apparatus according to claim 3, wherein when displaying the text document to be examined, a word included in the second difference information is displayed with a different character style.

11. The text document processing apparatus according to claim 3, further comprising an input unit for determining whether or not to network a word contained in the second difference information to the specified word in the standard knowledge network data.

12. The text document processing apparatus according to claim 4, further comprising an input unit for determining whether or not to network a word contained in the second difference information to the specified word in the standard knowledge network data.

13. The text document processing apparatus according to claim 2, wherein when displaying the text document to be examined, a word included in the matching information is displayed with a different character style.

14. The text document processing apparatus according to claim 3, wherein when displaying the text document to be examined, a word included in the matching information is displayed with a different character style.
